(19) United States
(12) Patent Application Publication
(10) Pub. No.: US 2002/0065786 A1
(43) Pub. Date: May 30, 2002

(54) Method and apparatus for depositing paper checks from home or office

(76) Inventors: Marco Martens, Chappaqua, NY (US); Charles P. Tresser, New York, NY (US)

Correspondence Address: McGuire Woods, LLP, Tysons Corner, Suite 1800, 1750 Tysons Boulevard, McLean, VA, 22102-3915, US

(21) Appl. No.: 09/920,740

(22) Filed: Aug. 3, 2001

Related U.S. Application Data
(60) Provisional application No. 60/252,584, filed on Nov. 24, 2000.

(51) Int. Cl. H04K 1/00; G06F 17/60

(52) U.S. Cl. 705/70; 705/45; 705/50

(57) ABSTRACT

A form of paper checks, and the apparatus and method to handle them, allows deposit from home or office. The apparatus can be implemented with a Personal Computer (PC) having a secure cryptography generator (SCG) installed. The process of depositing paper checks begins by the payee endorsing a check having printed thereon encryptions in at least selected locations where information is written by a payer. The act of writing by the payee obscuring some of the encryptions. The payee then scans the endorsed check with a scanner to generate a digitized version of the check. The computer extracts from the digitized version of the check a concatenated branch number, account number and check number and a corresponding digital signature. The payee then transmits the extracted information together with the digitized version of the check for deposit. The checks a specially designed to prevent fraud such alteration of the payee, amount and multiple deposits. In addition to the encryptions imprinted on the check, a secret key and a plurality of digital signatures are generated based on the concatenated branch number, account number and check number.

### CROSS-REFERENCE TO RELATED APPLICATION

This application claims the benefit of U.S. Provisional Application No. 60/252,584 filed Nov. 24, 2000.The subject matter of this application is related to the disclosures in U.S. patent application Ser. No. 09/398,028 filed Sep. 17,1999,by G. Braudaway, P. D. Howard, P. V. Kamesam, H. E. Sachar, F. C. Mintzer, C. W. Wu, J. M. Socolofsky, S. W. Smith, and C. P. Tresser for “Method and System for Remote Printing of Duplication Resistant Documents” and U.S. patent application Ser. No. 09/398,029 filed Sep. 17, 1999, by C. Mengin, H. E. Sachar, M. Martens and C. P. Tresser for “Method and Apparatus for Secure Sale of Electronic Tickets”. patent applications Ser. No. 09/398,028 and 09/398,029 are assigned to a common assignee herewith and their disclosures are incorporated herein by reference.

### DESCRIPTION

### BACKGROUND OF THE INVENTION

1. Field of the Invention

The present invention generally relates to a method and apparatus for depositing paper checks from home or office and the checks used for such deposit and, more particularly, to a method and apparatus which converts a specially designed paper check to digital form and allows secure electronic data transmission from a home or office computer to a bank for the purpose of depositing paper checks with the bank. A frequent fraud attempted against traditional check deposit is the so-called “amount fraud” where a dishonest person tries to change the amount of the check. The present invention also helps to protect against this fraud. More generally, the present invention makes fraud against checks harder, even when traditional methods of depositing are used.

2. Background Description

With the development of the World Wide Web (WWW) came the development of home banking. But there are still lots of basic banking operations which so far require one to go to a branch or to an Automated Teller Machine (ATM). The most important such operation is depositing a check, and more precisely a paper check as they have existed since much before the electronic age. While most of the rest of the world moves away from checks (although at a rather slow pace, about 4% per year in England, for instance), the use of checks is still growing in the U.S.A.

Allowing deposit from home or office would both be more practical for some customers, which helps in particular the banks for their Customer Relationship Management, and less costly for the banks. In particular, a check from the payee's location (from home or from the office or, for that matter, any other location), assuming it would be reasonably automated, would represent a considerable value for a variety of small, medium, and large businesses. In fact, even in countries where overall check traffic has been significantly decreased, there are businesses which still have to handle an increasing number of checks, which is very costly for them because of the work involved, and also to some extent, because of the errors and frauds involved.

When we speak about deposit from home or office, we assume that from a paper check, indeed a little piece of the physical world—we also say an analog entity—we first create a digital entity (we also speak about the digital form of the check). A digital entity is basically a set of symbols. Instead of an amorphous set of symbols, it might be more convenient to think of a set of symbols comprising groups of symbols that carry tags. The tags refer to which part of real world the group of symbols refers to and/or describe the role of the group symbol they are attached to, and/or describe the way this group relates to other groups of symbols. Such tags can indeed be explicit, or be implicitly contained in the way the overall set of symbols is formatted.

The digital form of a check does not fully replace the check, as long as the check is not destroyed in the process. We will assume that destroying the paper checks would not be acceptable, and that paper forms of check may be used is some lawsuit settlements. Thus, recourse to the paper form will only play a role extremely rarely. Consequently, for all practical purposes, we will in fact consider that the paper checks have been transformed to digital entities. Once in digital form, a check becomes quite close to an electronic check as the ones that have been considered by the Financial Services Technology Consortium (FSTC) (see http://www.fstc.org). Thus, most of the present disclosure will deal with two problems: generating checks from which secure digital versions can be extracted and how this extraction can be done with security and ease for all parties at hand (the payer, the payee, and their banks, and further parties as needed by the protocols) in the process of depositing from home or office. Once in digital form, protocols previously developed for electronic checks, or other forms of electronic payment systems, can be used in our context. On the other hand, what we will describe here to complete the deposit mechanism and its administration could be used for other secure transformations of documents into corresponding digital forms. Furthermore, the new kind of checks described in this invention will also make fraud much harder when traditional methods of depositing are used.

A few numbers will illustrate the size of check handling. In the U.S.A. in 1993, checks represented 80% of the noncash transaction volume for only 13% of the transaction value, with an average value per transaction of $1,150. While the use of checks has been declining in some countries, it is still increasing in some. The handling cost is huge for banks, and even more when bad checks are presented or frauds occur, such as multiple deposit attempts. Beside reducing the processing cost, allowing checks to be transformed to digital entities before being deposited would also help the overall transition to more forms of electronic payment systems.

For a general reference on electronic payment, see for instance Electronic Payment Systems by Donald O'Mahony, Michael Pierce, and Hitesh Tewari, Artech House, Boston (1997).

### Problems to Be Solved

As we mentioned before, to deposit checks from home, we assume the checks will be converted from their analog form to some digital form, in particular to allow data to flow using electronic means of communication. The problem is that the digital form allows easy data modification, a door open to easy counterfeiting. Furthermore, the very ease of data flow and copy in electronic form can also facilitate other forms of wrong doing.

The main problems to be solved can be formulated as follows:

1. No one should be able to create illegitimate checks. In particular, the reading of the paper check, involved in the transformation of the check into a digital form, should measure enough details of the check to assure that is it is very hard to make illegitimate checks that do pass the authenticity test based on the reading.

2. The amount should be very hard to change.

3. The payee's name should be very hard to change.

4. Multiple deposit of any check should be very hard.

As usual in the security business, very hard essentially means so hard that the cost of defeating the system would most probably be much higher than the benefit. It is clear that check depositing from home is more open to fraud than traditional check deposit. By solving the harder problem, the present invention also provides means to better protect against fraud in any form of check usage.

### SUMMARY OF THE INVENTION

It is therefore an object of the present invention to provide a form of paper checks, and the apparatus and method to handle them, that allows deposit from home or office while solving all problems we have mentioned above.

According to the invention, there is provided a method and apparatus, in combination with a special form of paper checks, which allows for the secure deposit of paper checks from home or office; in other words, at a location other than the bank or an ATM. The apparatus can be implemented at the payee's home or office with a Personal Computer (PC) which has a scanner attached to it and connected to the World Wide Web (WWW) on the Internet. The process of depositing paper checks begins by the payee endorsing a check having printed thereon encryptions in at least selected locations where information is written by a payer. The act of writing by the payee obscuring some of the encryptions. The payee then scans the endorsed check with a scanner to generate a digitized version of the check. The computer extracts from the digitized version of the check a concatenated branch number, account number and check number and a corresponding digital signature. The payee then transmits the extracted information together with the digitized version of the check for deposit. The checks are specially designed to prevent fraud such as alterations of the payee, amount and multiple deposits. In addition to the encryptions imprinted on the check, a secret key and a plurality of digital signatures are generated based on the concatenated branch number, account number and check number. Furthermore, the new kind of checks described in this invention will also make fraud much harder when traditional methods of depositing are used.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a pictorial representation of an actual IBM 4758 PCI Cryptographic Coprocessor;

FIG. 2 shows the front of a typical U.S.A. bank check and the various main area visible there;

FIG. 3 shows the back of a typical U.S.A. bank check and the various main area visible there;

FIG. 4 and FIG. 4A illustrate some of the visual security mechanisms on the front of a U.S.A. check;

FIG. 5 is a flow diagram illustrating how the most protective features are calculated at the payer's bank or its trusted mint, according to the present invention;

FIG. 6 shows the new features that would appear on the front of checks according to the present invention;

FIG. 7 shows the new features that would appear on the back of checks according to the present invention;

FIG. 8 shows the front of a typical U.S. check as it would appear when modified according to the present invention;

FIG. 9 shows the back of a typical U.S. check as it would appear when modified according to the present invention;

FIG. 10 is a flow diagram illustrating the process of depositing a check from home with a database; and

FIG. 11 is a flow diagram illustrating the process of depositing a check from home without a database.

### DETAILED DESCRIPTION OF PREFERRED EMBODIMENTS OF THE INVENTION

The present invention builds on a pair of technologies that we briefly discuss here. They are (1) a secure cryptography generator, such as the IBM 4758 PCI Cryptographic Coprocessor, and (2) the art of cryptography.

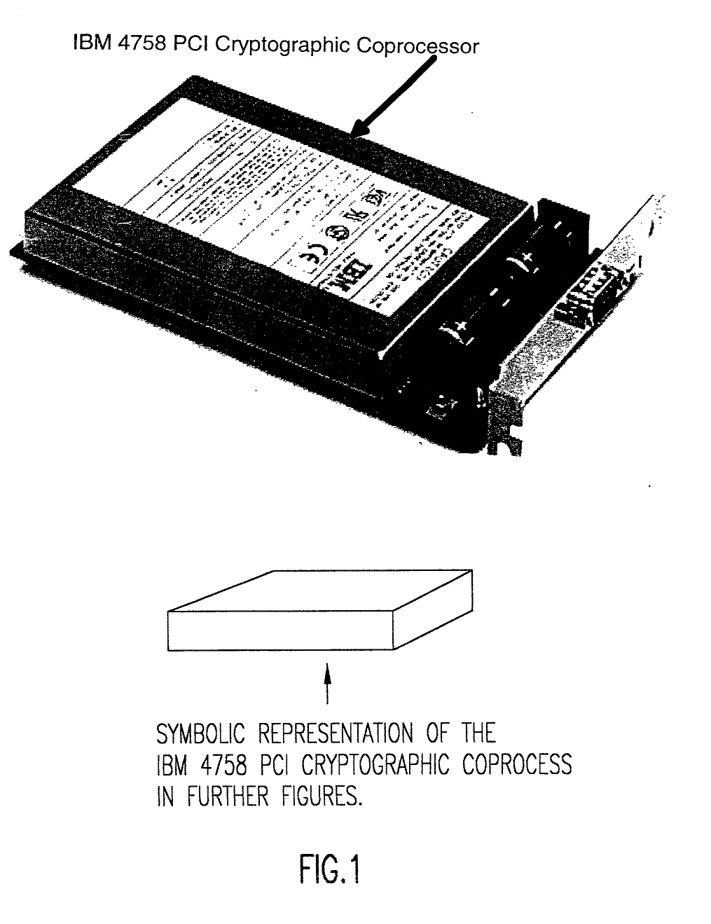

The IBM (International Business Machines Corp.) 4758 PCI (Peripheral Component Interconnect) Cryptographic Coprocessor (4758 for short) is a programmable, field upgradeable piece of secure hardware that has a general purpose computational power about equivalent to a personal computer (PC) from the early 90's. It is designed to plug into an available PCI connector of the PCI bus of a PC to provide the PC with a secure means of transmitting data over a standard telephone line. As shown in FIG. 1, the 4758 comprises a sealed processor 11 mounted to a printed circuit board (PCB) 12 having a PCI connector 13 along one edge. A battery 14, also mounted on the PCB 12, provides standby power to the processor 11 when the computer in which it is installed is turned off. The purpose of the battery is to maintain data in non-volatile memory within the processor 11. The PCB 12 is attached to a standard PC adapter mounting bracket 15 which fits into a slot at one end and is attached by a screw at the other end in the backplane of the PC cabinet. An RS-232 DB-9 serial connector 16 is mounted to the bracket 15 to permit connection from the 4758 to a modem. When configured in a PC, the 4758 occupies one of the serial port addresses, typically COM-1.

The 4758 performs high speed cryptographic operations, and provides secure key storage. It is both cryptographically secure and able to detect and protect itself against physical attacks (probe, voltage, temperature, radiation). It is in fact one of the only two devices that are Federal Information Processing Standard (FIPS) 140-1 overall 4 certified (hardware and microcode: certificate #35), the other one coming integrated in IBM 390 mainframes (the IBM CMOS (Complementary Metal Oxide Semiconductor) Cryptographic Coprocessor: certificate #40—which is not programmable as is the 4758—while the price of a 4758 is about a couple of thousand dollars. The 4758 is indeed a popular PCI bus interface for servers, and can serve as device driver for Operating Systems (OS) such as Microsoft Windows NT, Linux, and IBM's AIX, OS/2, and OS/390 Operating Systems. Typical use of cryptographic coprocessors such as the 4758, or some smart cards, include High Speed, Bulk Cryptography (for instance for digital movies, in-flight entertainment systems, secure databases, confidential video-conferences, telemedicine, telecommuting, etc.) and Security in Non Trusted Environments (for instance for smart card personalization, electronic currency dispensers, electronic benefits transfer, server-based smart card substitutes, home banking, certification authorities, secure database key control, electronic postage (epostage) meters, electronic payments, secret algorithms, secure time stamps, contest winner selection, software usage metering, electronic securities trading, hotel room gaming, etc.).

We have described in great detail the virtues of the 4758 because these virtues are the elements which are needed for the present invention to be implemented with the required level of high security. Any device with similar virtues could be used as well. The fact is that it is by no means obvious a priori that a machine with all these virtues could be built. We wanted to establish the feasibility—at the time of writing—of our overall invention by recalling in detail that assembling all the needed virtues in a machine can indeed be done, and giving an example proving that.

In the sequel, we will use SCG as an acronym for secure cryptography generator, an example of which is the 4758. What we mean is a machine which is secure for both physical and cryptographic attacks.

The use of secret keys as a means to encrypt or digitally sign a file or document, of secret encoding keys, and of secure hash functions (such as SHA-1, as fully specified in the Federal Information Processing Standard Publication 180-1) are now well known. A description of these techniques with directions on how to use several of their implementations can be found in Handbook of Applied Cryptography, by Alfred J. Menezes, Paul C. van Oorschot and Scott A. Vanstone, CRC Press, 1997.

To fix the ideas, we recall that a digital signature scheme is used in the form of a pair of functions Sign and Sign⁻¹ which are inverse of each other, i.e., for a plain text X to be signed, Sign⁻¹ (Sign(X))=X. The functions Sign and Sign⁻¹ are kept secret, being known only to some legitimate owner of the signature and his or her agents.

For definiteness, each time we use an encryption scheme, one can choose the Rivest-Shamir-Adleman (RSA) protocol as a method to generate a digital signature; several other methods could also be used (see, e.g., the Handbook of Applied Cryptography, cited above). In the case when the functions Sign and Sign⁻¹ are produced according to the RSA protocol, it is now preferred to use at least 1024 digits for X and Sign(X) (the formerly often used 512 digits are no more considered as secure). As a message may contain much more information than the length of the keys, several methods can be used, possibly concurrently, as is well known in the art. For instance, one can split the message in several pieces, some or all of which will be signed, or one can compress the information, for instance using a secure hash function, or one can select a subset of the information, etc. It might be beneficial to use several signatures schemes, say Sign₁, Sign₂, . . .

Also notice that even if one wishes to use the benefits of cryptography, it may be useful to also hide secret information in the messages, so that one could recognize that someone has succeeded to break the keys being used. This can be done in the form of secret functions, Sec₁, Sec₂, . . . As usual in the art, it is advisable to change the keys being used every so often, depending on the application, and to keep a list of former keys.

Another important enabler of secure electronic communication is the possibility to exchange secret keys while exchanging only messages which can be understood by third parties. Several protocols have been created to this effect such as the Diffie-Hellman protocol. Such protocols allow in particular several SCGs to have the same keys without the keys being compromised. The machines this way can also share one time pads, and other cryptographic function. In the sequel, when we speak of a SCG, we speak either of a single machine, or a series of them working in a coordinated way, as a multi-component single machine; i.e., memory will have to be shared. The invention does not depend on the distinction between these two cases, as long as the multiple machines are managed properly, avoiding in particular independent signatures by the components.

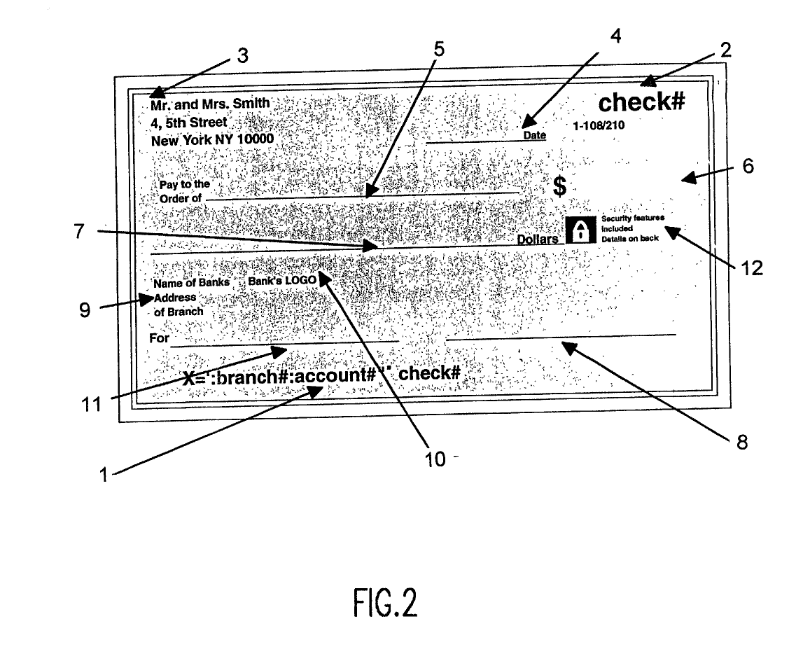

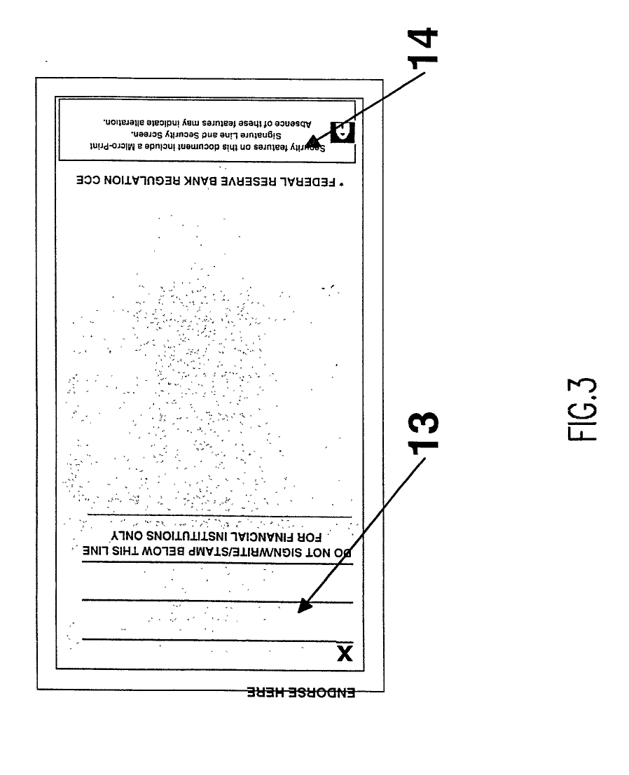

For ease of adoption by a majority of banks in some countries, it is important that the checks resemble the checks in use presently, so that the check could easily be processed in the usual way. Nowadays, checks usually carry several forms of counterfeiting protections to prevent in particular easy copy (which would allow multiple deposit) and alteration of the amount, and possibly also of the payee. For instance, in the U.S.A., checks often have explicit warnings about the security features that protect them, and a request to check theses features by whomever processes them. These will be described in more detail with reference to FIGS. 2 and 3. Some other features would need to be added to allow acceptable security levels in transfer to digital form.

Beside the current check data, usually of the form

“X=Bank Id number; Account Id number; Check number” shown at 21 on the front of the check in FIG. 2, the checks will carry a digital signature using a signature or Sign, which can either be the property of the issuing bank, or common property to a set of banks. The checks will possibly also carry a secret code encryption, using a key Sec₀, which is the property of a more restrictive community; i.e., Sec₀ is a more secret key. All these data will be clearly readable with a currently cheaply available scanner, and preferably also human readable. There may be machine readable entries and other entries that are human readable, or one can make the entry readable both ways; this applies to Sign₀(X) and also possibly to Sec₀(X). As mentioned before, one can use a plurality of signatures and secret functions.

Other digital signatures and secret keys will be used to create numbers which will be finely printed in appropriately chosen areas, also called fields or critical fields. These include where the amounts (numbers and/or text) are written at 26 and 27, where the payee's name is written at 25, preferably also where the human signatures (payer's signature and endorsement) are written 28, preferably also where the check is endorsed at 33 in FIG. 3, and preferably also where the date is written at 24 in FIG. 2.

All writing on the checks by the payer (in particular amounts, signature, payee's name, and also preferably the date) will be made with dark, preferably wide, pens, so that if the amounts are changed on the digital copy, some secret bits of information cannot be recovered by the counterfeiter.

Using these three principles, any changed amount or changed payee's name can be recognized as invalid. For that, the small prints in the payee and amounts areas will need to change from check to check.

Illegitimate signature protection is mostly about protecting against copying a signature from one check to another check (for instance after stealing or finding a blank check). An often used protection against copying human signatures is to recognize that a signature is perfectly identical between several (two or more) checks. Especially in digital form, it is easy to change slightly the shape and position on the check of a signature in order to defeat this protection, but then the fine print to be covered would be different. Thus, for better protection, the fine print in the signature area will preferably change from check to check. For better protection, one might also consider the fine print covering the sensitive areas to comprise signatures of the form Sing(X) and the more secret Sec(X).

Similar protection for the date area is expected to play a less critical role, but could help defeating for instance using old checks which have expired.

The data of the check (X, payee's name, amount, date) will be registered on some accessible write only database together with the name of the bank where the deposit will be made, before the deposit or as part of the deposit.

To avoid malignant use of the database by people willing to block checks non-legitimately, it would be better to also register one or more of the digital signatures on the checks at the same time as the check numbers.

Since the full set of presently available data on checks indicate the emitting bank branch, the database can be partitioned, either logically or geographically, or both, according to these branches (with further partition corresponding to the account number). This would allow easy and quick access to the database even when the database increases with usage.

Such database could be administrated in several forms by specialized institutions such as clearing houses or by all or some banks.

One also needs to protect against fraud which consists of depositing a check both electronically and traditionally (at a bank or ATM). Thus, for the process of home depositing to marry well with regular paper check deposits at the branches or ATMs, numbers on regularly deposited checks would also be checked against the database, but then the digital signature(s) of the check data would not need to be registered, if the bank where the deposit is made registers itself to verify the check data have been legitimately registered. In fact, such database would offer first level protection against multiple deposit in either the digital, mixed analog-digital, or pure analog world.

Although the database approach we just described seems the most appropriate way to go, we also describe a way to avoid the database protection using secure hardware. Anyone or any company or company branch (anything that can be the payee of a check) will be allowed to get a single 4758 (or similar SCG machine) with the special function of signing the fact that check numbers are used only once. Replacement of the machine will be allowed only if proof can be made that the previous one will not be used anymore (e.g., exchange of the new machine when giving back the old one).

It will be important that payee's name be not left blank in the case secure hardware is used as the protection against multiple deposit, while this is less relevant with the database protection approach.

So far, we have supposed that the circulation of data once the check is transformed to digital form follow the same path as a paper check, in particular going from the payee to his or her bank. The FSTC has realized that once in electronic form, checks do not need to be handled the same way as regular checks in terms of the data circulation. They distinguish between several forms of circulation (see for instance the previously mentioned book Electronic Payment Systems by D. O'Mahony et al.). For instance:

Deposit-and-clear mirrors the flow for real check, and is what we had in mind so far, in particular for the problem of multiple deposit prevention.

Cash-and-transfer uses a direct link between the payee and the payer's bank, so that the multiple deposit is much easier to protect against, since the emitter's bank can easily take care of its own database.

There are further scenarios in the world of electronic checks. Some of them make these forms of payment further and further away from regular checks. Anyone versed in the art of payment systems would easily adapt the principle of the present invention to any such system, as what this invention provides is a way to create and use paper documents which allows for secure and uniquely usable transfer to digital form.

Referring again to FIGS. 2 and 3, a typical American check is represented, respectively, on the front and back sides. There are several distinctive fields on the check, also called critical fields. We call X the long number usually on the bottom left of the face of the check at 21, made by concatenating the branch number, the account number, and the check number for that account:

“X=Bank Id number; Account Id number; Check number”.

The check number itself is repeated, usually on the upper right comer of the face at 22. The name and address of the account owner (an individual or a company) is usually on the upper left of the face at 23, sometimes also with a telephone number, and/or some other sorts of numbers in the case of a corporation. Different fields to be written on will carry the date at 24, the payee's name (individual or business) at 25, the numerical amount at 26, and the written amount at 27. A field is designed to carry the signature at 28. The name of the bank appears at 29. The logo of the bank appears at 30. A place to write what the check is for appears at 31. Sometime a notice is given that the check is equipped with counterfeiting adverse features appears at 32, sending for the back of the check for more details.

In FIG. 3, on the back of the check, an area is reserved for endorsement at 33. And some description of the counterfeiting adverse features may be given at 34, as indicated at 32 (FIG. 2), with advices to people to reject the check if some of these features are compromised.

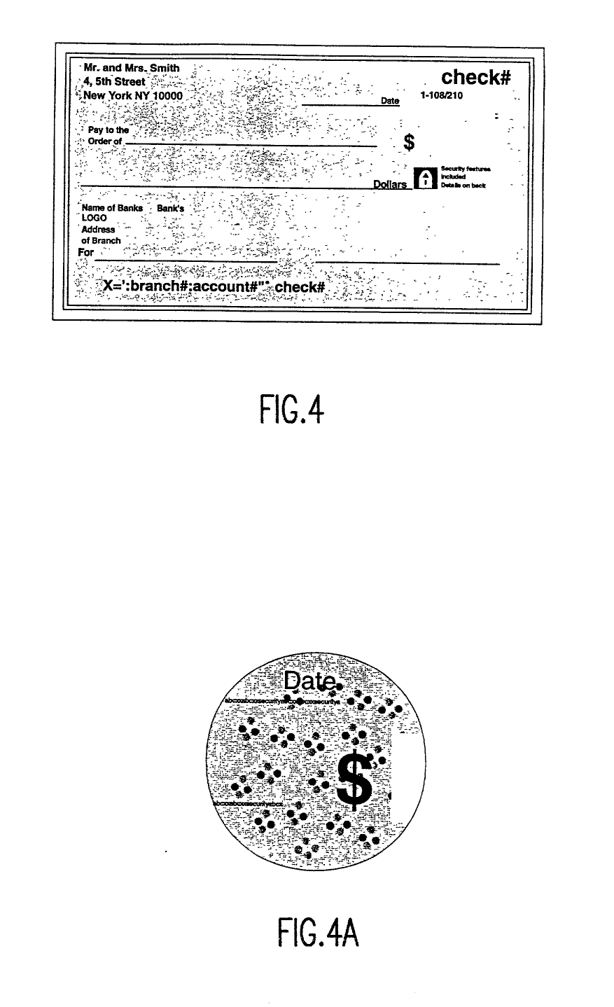

FIG. 4, and the enlarged area shown in FIG. 4A, represents some of the visual protections often used on a check. This is in the form of a screen (manifested by small color dots on the background of the check) and micro prints on some important lines, as shown in FIG. 4A. Checks will be modifications of checks as they are used presently, preserving all current security features, and adding some to allow for deposit from home or from the office as described above, and detailed below. Checks would for instance be printed by specialized companies, as they are now, according to these principles. Alternatively, to produce blank checks according to the present invention, one could use the methods to print securely from home or office as described for instance in the applications for U.S. patent applications Ser. No. 09/398,028 and 09/398,029.

Whichever way the blank checks are produced, they should carry marks for easier justification since the checks will be machine read and minute details on the checks will need to be read for the security features to work in the case of deposit from home or office.

With reference now to FIGS. 2, 3 and 5 to 9, the new protections of the check, according to the present invention, consist of properly placed encryptions of the unique identifier of the check such as the usual data X

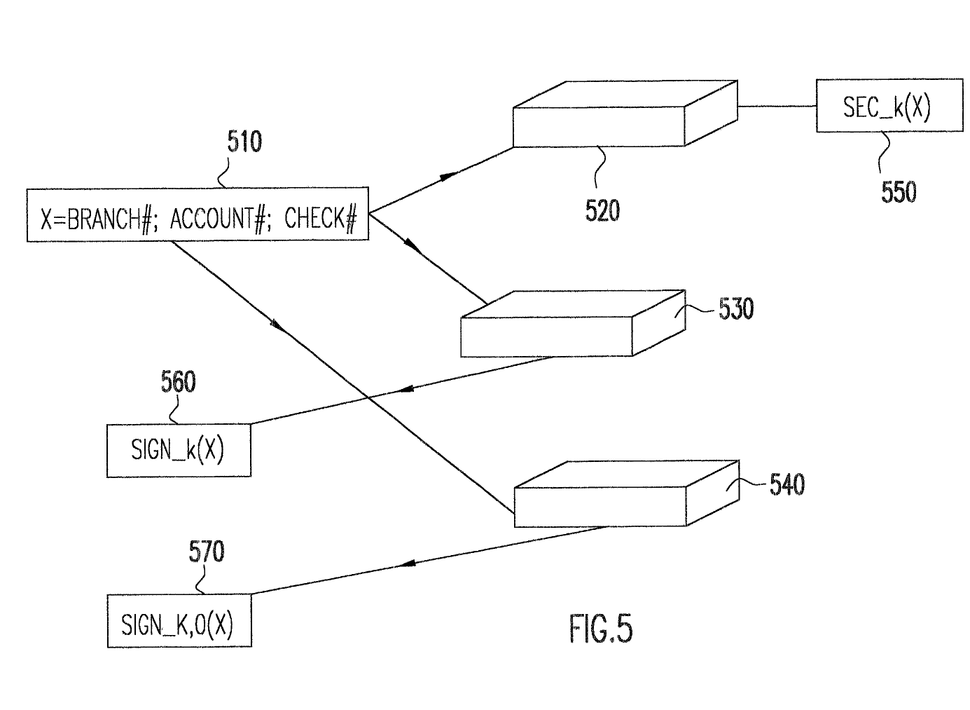

“X=Bank Id number; Account Id number; Check number” at 510 (FIG. 5). The critical fields of the check which carry for example the amount, the payee's name, etc. will be assigned a number k=1,2,3, . . . , as shown in FIGS. 2 and 3. Each field is going to be covered with fine print encrypted versions of X. Preferably the field k will be covered with at least three encrypted versions of X, Signₖ(X), Sign_{k,0}(X), and Secₖ(X). These signatures and their use are described below. First, we describe a method to cover each field k=1,2,3. . . The whole area of field k should be covered. This will in general require a large number of lines of fine print. Each line should comprise different encryptions of X. Consequently, each signature Signₖ(X), Sign_{k,0}(X), Secₖ(X) will thus be in fact a family of different signatures or encryption functions. Families are needed to be able to construct a covering with multiple lines. The encryption functions Signₖ, Sign_{k,0} and Secₖ, indexed by the field number k should be different for different k, as details obscured for instance by the signature could, for instance, be recovered from the amount field. It is for similar reasons that each encryption function Signₖ, Sign_{k,0} and Secₖ should consist of a family of different encryption functions as otherwise different lines using, for instance, Secₖ(X) which have been obscured at different places could be used to reconstitute the full signature Secₖ(X).

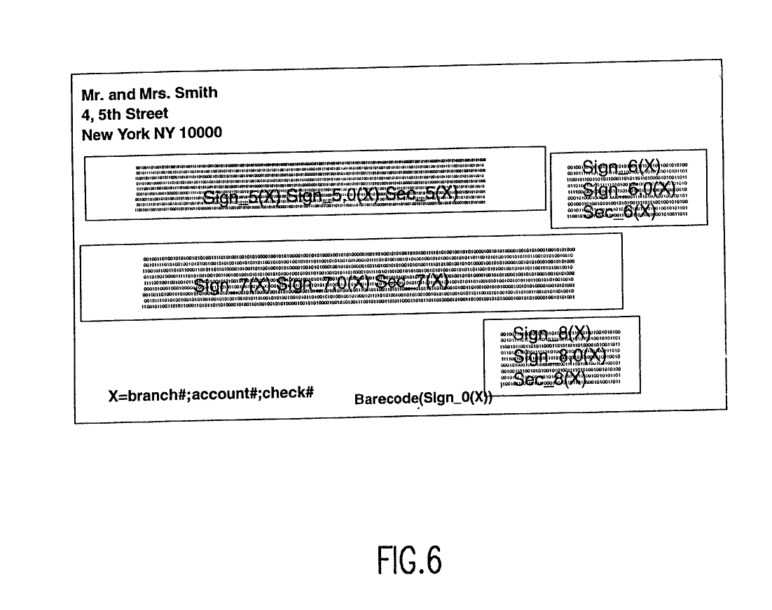

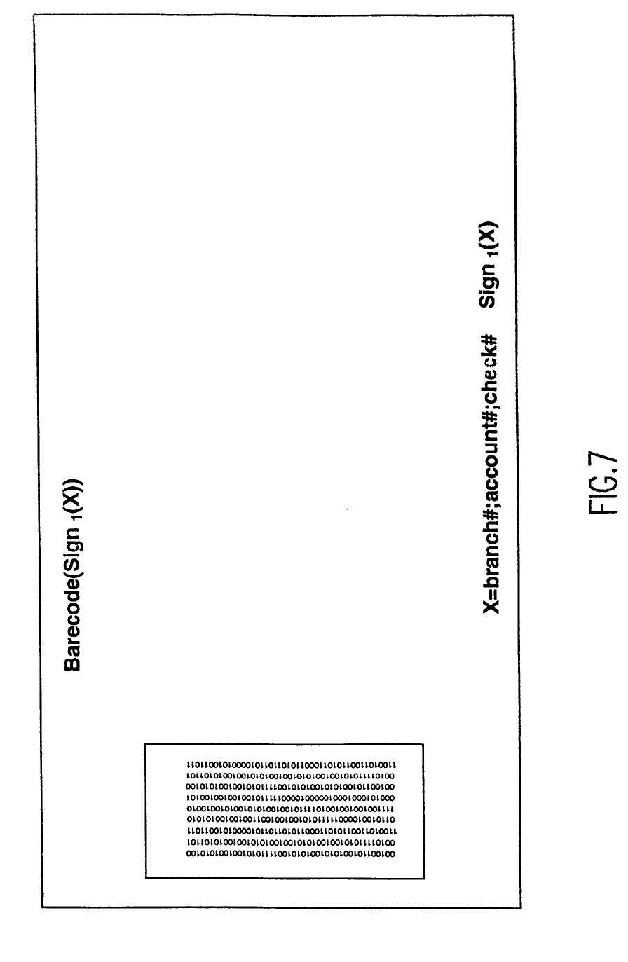

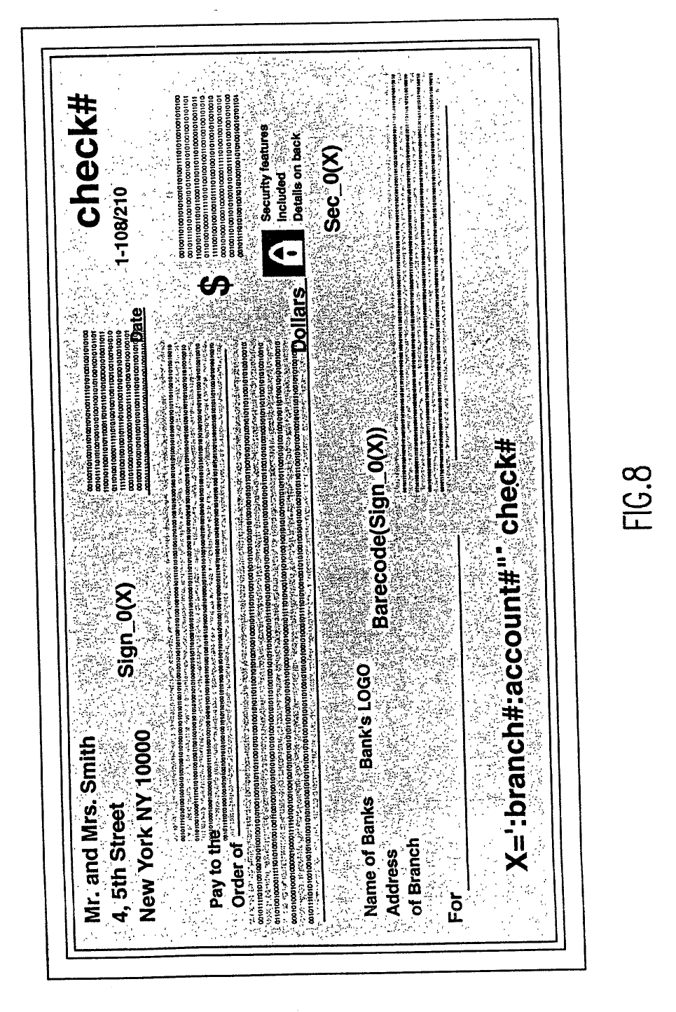

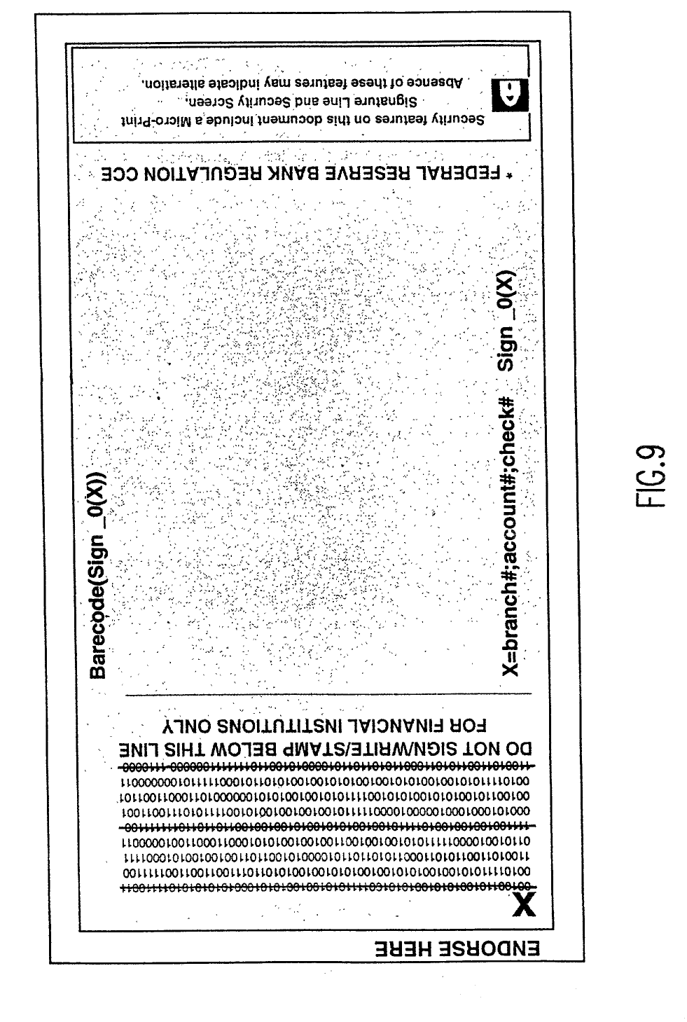

With reference now to FIGS. 6 and 7 there are shown examples of where the protecting encryptions we just described should appear in a standard check (both front and back), while FIGS. 8 and 9 illustrate how this would appear in the context of a typical U.S. check. FIG. 6 shows alternation of lines of the form Sign₈(X), Sign₈ known by all banks and Sign_{8,0}(X), Sign_{8,0} known by the payer's bank.

With reference to FIG. 5, the different signatures will be described. For each field k=1,2,3, . . . of the check, the issuing bank chooses a key Signₖ (in fact, usually a family of them, as discussed previously) using a SCG (or a plurality of them) at 530. The key Signₖ thereby produced at 530 will be transmitted to other SCGs which will be distributed to banks and other authorized institutions involved in the depositing process of the checks described in this invention. The key Signₖ will be used to compute Signₖ(X) at 560. Using a SCG or a plurality of them would be preferable. This signature allows the payee's bank to perform a first authentication.

Again referring back to FIG. 5, the issuing bank then chooses a second secret key Sign_{k,0} (or a family of them—again we prefer a family for the same reasons detailed above) using a SCG at 540. The key Sign_{k,0} will remain the exclusive property of the issuing bank, and using SCGs, will be communicated to all branches of the issuing bank where check clearing is done. Sign_{k,0} will be used to generate a second signature Sign_{k,0}(X) of X (or family thereof) at 570, which, in very fine print, will fill in most of what remains after the previous operation of the crucial spaces on the check such as the amount fields (numbers and letters fields), the payee's name, the human signatures (payer's signature and endorsement signature), and preferably also the date field. This signature Sign_{k,0} (X) will only be used exclusively by the issuing bank and branches involved in the clearing of checks.

Referring back to FIG. 5, the issuing bank then chooses a third encryption key Secₖ (or family of them) using a SCG at 520. The secret key Secₖ thereby produced at 540 is exclusively known to the most trustable parts of the issuing bank and used as a final instrument to verify the check. Using the key Secₖ, a family of signatures Secₖ (X) will be produced at 550. These signatures will, in very fine print, fill in what remains after the use of Signₖ(X) and Sign_{k,0}(X) partially crucial spaces on the check such as the amount fields (numbers and letters fields), the payee's name field, the payer's signature field, the endorsement field on the back, and preferably also the date field as illustrated in FIGS. 6 and 7 for generic checks, and in FIGS. 8 and 9 for typical U.S. checks.

The payer uses a dark pen, preferably with a rather wide trace on paper (about ¼ mm, or preferably more), and writes the amounts, payee's name or designation, and signs. Any of these acts obscure partially the signatures Secₖ(X), Signₖ(X) and Sign_{k,0}(X) in the fields k=1,2,3. . . in which they are performed. Any of these acts can be performed using machines instead of hand writing. Of course, if the signature is also machine made, special protection has to be used, such as encryption of the color or of any details incorporated in or added to the signature, as would all be easy to design and implement by anyone trained in the art. As described before, the payer can either use preprinted checks, or checks printed from his or her own printer according to some method allowing to do that with the required level of security.

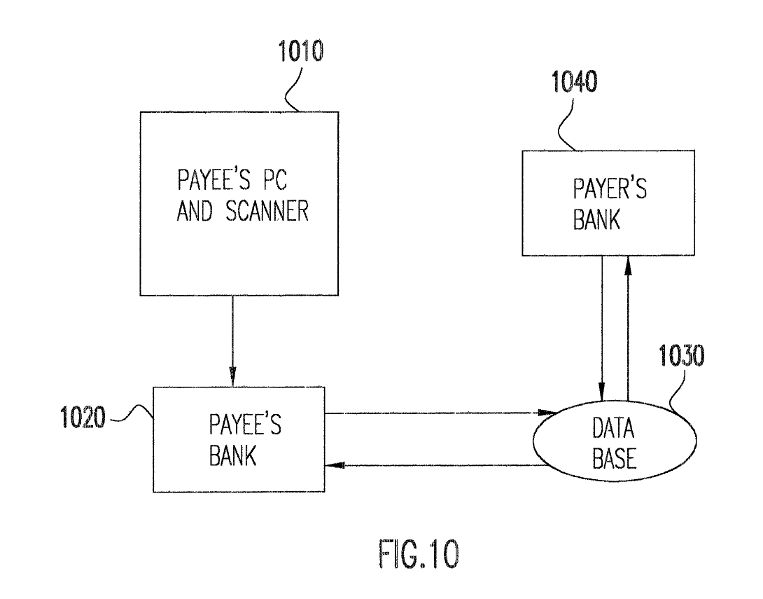

The payee will first endorse the check as usual, except for the preference of large dark pens as discussed above for the payer. Then, as shown in FIG. 10, the payee next scans the checks with a sufficiently high resolution scanner at 1010. Reasonably inexpensive scanners with 600 dots per inch resolution or above are easily available. Such resolution would be enough to detect marks of sizes which are easily covered by regular writing, even more so by wide pens as described above. The scan is the first electronic form of the check. One could either extract all information from the scan at the payee's location, or only the data needed for multiple deposit prevention; i.e., the usual check data

“X=Bank Id number; Account Id number; Check number” and corresponding digital signature Sign₀(X). The rest of the data on the image of the check can be extracted either at the deposit point or at the payee's location.

Referring again to FIG. 10, In the deposit and clear case, the payee will transmit the digital image of the check, or some subset of the corresponding data that contains all relevant information, to the bank at 1020 where he or she wants to make the deposit, and indicate the account where deposit should be made, after endorsing the check.

In the case of using databases for multiple deposit prevention, before communicating such data stream to his or her bank, the payer will register the check data X and corresponding first digital signature Sign₀(X) to a database 1030 of the payer's bank or a specialized service.

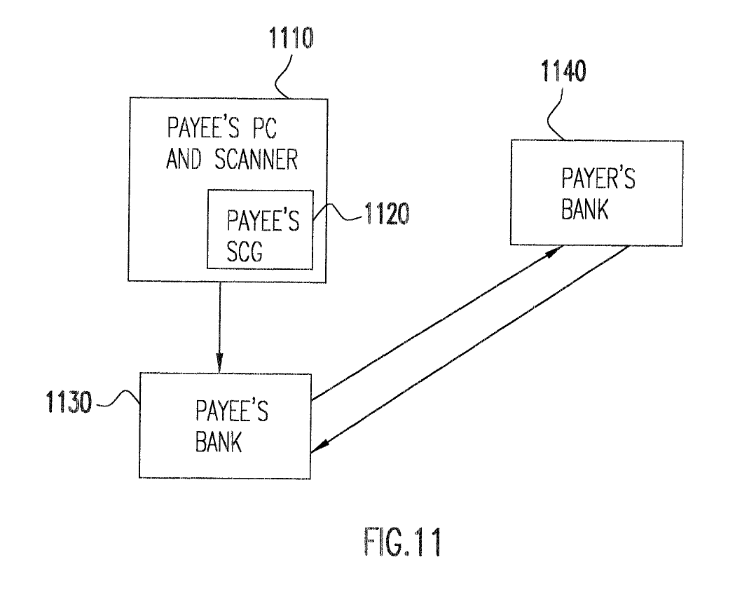

Alternatively, in the case of using secure hardware for multiple deposit prevention as shown in FIG. 11, the payee will use an SCG 1120 to register the check data. The SCG 1120 responds to the prompt by giving its own digital signature Sign_{SCG}(X) of the check data, if and only if, the check data under consideration is registered for the first time. Indeed, the SCG approach may be particularly adapted to the case of corporate payees and particularly valuable customers. Whenever the SCG solution is chosen, the number Sign_{SCG}(X) has to be sent to the payee's bank 1130 with the rest of the check information.

Assume now that, for some reason the payee decides to deposit conventionally the paper check. In the database case shown in FIG. 10, the database 1030 will be checked by the bank where the deposit is made. In the SCG case shown in FIG. 11, the SCG 1120 will be asked to provide a special signature that guarantees the check has not been registered for deposit from home. Multiple component SCGs would avoid the very rare bad luck of having a machine fail at the wrong moment. Customers that deposit large numbers of checks may indeed be required by the banks to have multiple components SCGs, if the SCG solution is chosen.

The manner of handling of the check by the payee's bank in the deposit-and-clear case is as follows. Upon receiving the check image, or relevant part thereof, the payee's bank first verifies the deposit is the first one on this check. Then the bank verifies all authentication data it can, before transmitting the check image, or relevant part thereof, to the payer's bank to initiate the clearing process. The signatures Signₖ(X) are among the relevant data the payee's bank can verify. It knows the key Signₖ to produce such a signature.

The manner of handling of the check by the payer's bank in the deposit-and-clear case is as follows. The payer's bank 1040 then checks all information on the check image, or only the one the payee's bank could not perform, depending on the relationship between the banks, and proceeds to clearing as in usual business.

In the cash-and-transfer case, and other payment mechanisms, the database approach will be encouraged by the fact that the payee and the payer's bank will have to interact anyhow. Details of the processes to be used for all sorts of payment mechanisms should be obvious to anyone versed in the art of payment, based on the details given in most usual but rather complicated deposit-and-clear case.

The motivation of our invention was to allow for the secure deposit of paper checks from home or office; however, the invention is applicable to the prevention of fraud in a variety of documents and commercial paper. Thus, while the invention has been described in terms of preferred embodiments, those skilled in the art will recognize that the invention can be practiced with modification within the spirit and scope of the appended claims.

Having thus described our invention, what we claim as new and desire to secure by letters patent is as follows:

1. A method of protecting a document which will be transformed into a value bearing instrument after adding additional markings to the document from fraudulent alteration of the markings comprising the steps of:
generating encryptions of a unique identifier X of the document, the unique identifier X being printed on the document; and
covering each critical field k, k=1,2,3. . . , of the document where markings are to be added with encrypted versions of X, Sign_{k,0}(X), where Sign_{k,0}(X) is a cryptographic function or family thereof which is known only to an institution which issues the document, Sign_{k,0}(X) being used to authenticate the document.

2. The method of protecting a document from fraudulent alteration recited in claim 1, wherein an entire area of a field k is covered with a large number of lines of fine print, the lines of fine print comprising one of several encryptions of X.

3. The method of protecting a document from fraudulent alteration recited in claim 2, wherein each critical field k of the document, in addition to being covered by the encrypted version of X, Sign_{k,0}(X), is covered with another encrypted version of X, Signₖ(X), where Signₖ(X) is another cryptographic function or family thereof different from the cryptographic function Sign_{k,0}(X) which is known to a larger number of authorized institutions for performing an initial authentication of the document.

4. The method of protecting a document from fraudulent alteration recited in claim 2, wherein each critical field k of the document, in addition to being covered by the encrypted version of X, Sign_{k,0}(X), is covered with another encrypted version of X, Secₖ(X), where Secₖ(X) is another cryptographic function or family thereof different from the cryptographic function Sign_{k,0}(X) which is known to a small group within the institution which issues the document for performing final authentication of the document

5. The method of protecting a document from fraudulent alteration recited in claim 3, wherein each critical field k of the document, in addition to being covered by encrypted versions of X, Signₖ(X) and Sign_{k,0}(X), is covered with a third encrypted version of X, Secₖ(X), where Secₖ(X) is another cryptographic function or family thereof different from the cryptographic functions Sign_{k,0}(X) and Signₖ(X) which is known to a small group within the institution which issues the document for performing final authentication of the document

6. The method of protecting a document from fraudulent alteration recited in claim 5, further comprising the step of indexing the cryptographic functions Signₖ, Sign_{k,0} and Secₖ, by a number corresponding to the field k, so that each line comprises different encryptions of X such that each cryptographic function Signₖ(X), Sign_{k,0}(X) and Secₖ(X) is a family of different cryptographic functions.

7. The method of protecting a document from fraudulent alteration recited in claim 6, wherein the families of cryptographic functions Signₖ, Sign_{k,0} and Secₖ prevent cryptographic functions which have been obscured at different places by marks added to the document from being used to reconstitute the full cryptographic function.

8. The method of protecting a document from fraudulent alteration recited in claim 1, wherein electronic deposit of a document transformed into a value bearing instrument comprises the steps of:
scanning the document with a scanner to generate a digitized version of the document; and
transmitting the digitized version of the document for deposit.

9. The method of protecting a document from fraudulent alteration recited in claim 8, wherein electronic deposit of a document transformed into a value bearing instrument further comprises the step of endorsing the document, if needed, having printed thereon encryptions in at least selected locations where markings are added to transform the document into a value bearing instrument, the act of endorsing obscuring some of the encryptions.

10. The method of protecting a document from fraudulent alteration recited in claim 8, wherein electronic deposit of a document transformed into a value bearing instrument further comprises the steps of:
extracting from the digitized version of the document the unique identifier X and a corresponding digital encryption of X, Signₖ(X), which is known to a large number of authorized institutions; and
comparing a decrypted version of Signₖ(X) to the unique identifier X as an initial authentication of the document.

11. The method of protecting a document from fraudulent alteration recited in claim 10, wherein electronic deposit of a document transformed into a value bearing instrument further comprises the steps of:
extracting from the digitized version of the document the unique identifier X and a corresponding digital encryption of X, Sign_{k,0}(X), which is known only to an institution that issues the document; and
comparing a decrypted version of Sign_{k,0}(X) to the unique identifier X as a further authentication of the document.

12. The method of protecting a document from fraudulent alteration recited in claim 11, wherein electronic deposit of a document transformed into a value bearing instrument further comprises the steps of:
extracting from the digitized version of the document the unique identifier X and a corresponding digital encryption of X, Secₖ(X), which is known to a small group within the institution that issues the document; and
comparing a decrypted version of Secₖ(X) to the unique identifier X as a final authentication of the document.

13. The method of protecting a document from fraudulent alteration recited in claim 1, wherein portions of the lines of fine print are obscured by writing added to the document when transforming the document into a value bearing instrument.

14. The method of protecting a document from fraudulent alteration recited in claim 13, wherein the document is a check and the unique identifier X is check data comprising a bank Id number, an account Id number and a check number.

15. The method of protecting a document from fraudulent alteration recited in claim 14, wherein an issuing bank chooses a first secret key Signₖ using a secure cryptographic generator (SCG), further comprising the steps of:
computing a first family of encrypted functions Signₖ(X); and
communicating the key Signₖ to banks and other authorized institutions involved in depositing of checks, the family of encrypted functions Signₖ(X) allowing the payee's bank to perform a first authentication of the check.

16. The method of protecting a document from fraudulent alteration recited in claim 15, wherein an issuing bank chooses a second secret key Sign_{k,0} using a SCG, further comprising the steps of:
computing a second family of encrypted functions Sign_{k,0}(X), key Sign_{k,0} remaining the exclusive property of the issuing bank; and
using SCGs, communicating the key Sign_{k,0} to all branches of the issuing bank where check clearing is done, the family of encrypted functions Sign_{k,0}(X) being used exclusively by the issuing bank and branches involved in the clearing of checks.

17. The method of protecting a document from fraudulent alteration recited in claim 16, wherein an issuing bank chooses a third secret key Secₖ which is exclusively known to a small group within the issuing bank, further comprising the step of computing a third family of encrypted functions Secₖ(X), the secret key Secₖ being used by the issuing bank as final instrument to verify the check.

18. The method of protecting a document from fraudulent alteration recited in claim 14, wherein the check is deposited by a payee electronically from a location remote from a bank or Automatic Teller Machine (ATM).

19. The method of protecting a document from fraudulent alteration recited in claim 14, wherein electronic deposit of the check by a payee comprises the steps of:
endorsing the check having printed thereon encryptions in at least selected locations where information is written by a payer, the act of endorsing by the payee obscuring some of the encryptions;
scanning the endorsed check with a scanner to generate a digitized version of the check;
transmitting the digitized version of the check for deposit to the payee's bank.

20. The method of protecting a document from fraudulent alteration recited in claim 19, wherein electronic deposit of the check by a payee comprises the steps of:
extracting by the payee's bank from the digitized version of the check the unique identifier X and a corresponding digital encryption of X, Signₖ(X), which is known to a large number of authorized institutions including the payee's bank; and
comparing by the payee's bank a decrypted version of Signₖ(X) to the unique identifier X as an initial authentication of the check.

21. The method of protecting a document from fraudulent alteration recited in claim 20, wherein electronic deposit of the check further comprises the steps of:
extracting from the digitized version of the check the unique identifier X and a corresponding digital encryption of X, Sign_{k,0}(X), which is known only to a bank that issues the check; and
comparing by the payor's bank a decrypted version of Sign_{k,0}(X) to the unique identifier X as a further authentication of the check.

22. The method of protecting a document from fraudulent alteration recited in claim 21, wherein electronic deposit of the check further comprises the steps of:
extracting from the digitized version of the check the unique identifier X and a corresponding digital encryption of X, Secₖ(X), which is known to a small group within the bank that issues the check; and
comparing a decrypted version of Secₖ(X) to the unique identifier X as a final authentication of the check.

23. The method of protecting a document from fraudulent alteration recited in claim 19, further comprising the step of accessing a database by the payee's bank where the unique identifier X and first encrypted function Signₖ(X) is registered to determine whether the check has been previously presented for deposit.

24. The method of protecting a document from fraudulent alteration recited in claim 19, further comprising the step of registering a check to be deposited by the payee with an SCG to prevent multiple deposits.

25. A document protecting against fraudulent alteration of markings added to the document to transform the document into a value bearing instrument, the document having printed thereon and covering each critical field k, k=1,2,3. . . , where markings are added to the document encrypted versions a unique identifier X printed on the document, Signₖ₀(X), where Signₖ₀(X) is a cryptographic function or family thereof which is known only to an institution which issues the document, Signₖ₀(X) being used to authenticate the document.

26. The document recited in claim 25, wherein an entire area of field k is covered with a large number of lines of fine print, the lines of fine print comprising an encryption of X.

27. The document recited in claim 26, wherein each critical field k of the document, in addition to being covered by encrypted versions of X, Signₖ₀(X), is covered with another encrypted version of X, Signₖ(X), where Signₖ(X) is another cryptographic function or family thereof different from the cryptographic function Sign_{k,0}(X) which is known to a larger number of authorized institutions for performing an initial authentication of the document.

28. The document recited in claim 27, wherein each critical field k of the document, in addition to being covered by encrypted versions of X, Sign_{k,0}(X) and Signₖ(X), is covered with a third encrypted version of X, Secₖ(X) is another cryptographic function or family thereof different from the cryptographic functions Sign_{k,0}(X) and Signₖ(X) which is known to a small group within the institution which issues the document for performing final authentication of the document.

29. The document recited in claim 28, wherein the cryptographic functions Signₖ, Sign_{k,0} and Secₖ, are indexed by a number corresponding to the field k, so that each line comprises different encryptions of X such that each cryptographic function Signₖ(X), Sign_{k,0}(X), Secₖ(X) is a family of different cryptographic functions.

30. The document recited in claim 29, wherein the act of adding markings to the document to transform the document into a value bearing instrument obscures some of the encryptions, the families of different cryptographic functions preventing cryptographic functions which have been obscured at different places from being used to reconstitute the full cryptographic function.

31. The document recited in claim 25, wherein the document is a check and the unique identifier X is check data comprising a bank Id number, an account Id number and a check number.

32. The document recited in claim 31, wherein the act of adding markings to the check to transform the document into a value bearing instrument obscures some of the encryptions

33. The document recited in claim 32, wherein an entire area of field k is covered with a large number of lines of fine print, the lines of fine print comprising an encryption of X.

34. The document recited in claim 33, wherein each critical field k of the document, in addition to being covered by encrypted versions of X, Signₖ₀(X), is covered with another encrypted version of X, Signₖ(X), where Signₖ(X) is another cryptographic function or family thereof different from the cryptographic function Sign_{k,0}(X) which is known to a larger number of authorized banks and institutions for performing an initial authentication of the check.

35. The document recited in claim 34, wherein each critical field k of the document, in addition to being covered by encrypted versions of X, Sign_{k,0}(X) and Signₖ(X), is covered with a third encrypted version of X, Secₖ(X) is another cryptographic function or family thereof different from the cryptographic functions Sign_{k,0}(X) and Signₖ(X) which is known to a small group within the bank or institution which issues the check for performing final authentication of the check.

36. The document recited in claim 35, wherein the encrypted function Signₖ(X) are communicated to banks and other authorized institutions involved in depositing checks and the encrypted function Signₖ(X) allows the payee's bank to perform a first authentication of the check.

37. The document recited in claim 36, wherein key Sign_{k,0} remains the exclusive property of the issuing bank and the encrypted function Sign_{k,0}(X) is used exclusively by the issuing bank and branches involved in the clearing of checks.

38. The document recited in claim 37, wherein secret key Secₖ is exclusively known to the issuing bank and the encrypted function Secₖ(X) is used by the issuing bank as a final instrument to verify the check.
